(19) United States
(12) Patent Application Publication
(10) Pub. No.: US 2009/0045172 A1
(43) Pub. Date: Feb. 19, 2009

(54) METHOD OF OPEN ROOT WELDING

(75) Inventor: Peter Van Erk, Raamsdonksveer (NL)

Correspondence Address: HAHN LOESER & PARKS, LLP, One GOJO Plaza, Suite 300, AKRON, OH, 44311-1076, US

(73) Assignee: LINCOLN GLOBAL, INC., City of Industry, CA (US)

(21) Appl. No.: 11/837,940

(22) Filed: Aug. 13, 2007

(51) Int. Cl. B23K 31/02; B23K 9/00

(52) U.S. Cl. 219/61; 219/121.46

(57) ABSTRACT

A method of welding the ends of two pipe sections at the open root between said spaced ends, said method comprising: selecting a metal cored welding wire having a metal sheath and a core, the wire comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum.

### FIELD OF THE INVENTION

The present invention relates to a method of welding open root joints (“root joints”), such as those arising between two plates or pipes. More specifically, the method utilizes a particular metal cored wire or electrode for welding root joints, in conjunction with surface tension transfer (“STT”) short circuit electric arc welding.

### INCORPORATION BY REFERENCE

The present invention relates to an improvement in spatter controlled systems and heat control systems of the general type described in the U.S. Pat. Nos. 5,148,001; 5,003,154; 5,001,326; 4,972,064; 4,897,523; 4,866,247; and 4,717,807. Further, the present invention relates to an improvement in root welding as generally described in U.S. Pat. Nos. 6,204,478 and 6,093,906. Finally, the present invention relates to the use of metal cored wires in the STT welding process as generally described in U.S. Pat. Nos. 6,215,100; 6,051,810; and 5,961,863. All prior issued patents listed above are incorporated by reference herein as background information and for their discussion of concepts in the spatter control area to which the present invention is specifically directed.

Also incorporated by reference is U.S. Pat. No. 5,676,857. This prior issue patent is incorporated by reference herein as background information and for its discussion of welding sections of pipe together.

### BACKGROUND OF INVENTION

Open root joints generally comprise a pair of spaced apart ends or edges of plate, pipe, or the like, which are then joined by a weld. Open root joints often arise when joining adjacent pipe sections. In this context of pipe welding, one or more welding heads may be moved around the pipe to provide a 360° weld. The weld is usually made in several steps. First, a root pass is made where at least the inner edges or lands of the pipes are fused and the gap between the lands filled with weld metal. Thereafter, several filler passes are made wherein the space formed by the bevel is filled so that the weld metal is at least flush with the outer surface of the pipe.

Because the root pass is the initial pass that adjoins and secures the opposing pipe sections, the root pass is crucial. Therefore, during the root pass, a 100% sound weld bead should be laid. Soundness of the weld bead means the complete fusion of both pipe sections and the complete filling of the gap between the adjoining pipes sections with the weld metal. It is also necessary that the molten weld metal does not protrude inwardly of the pipe section to any substantial distance, as the inner surface should be substantially smooth and free of any protrusions that may prevent the travel of any pig, inspection device, or any other cylindrical devices through the pipe, and/or initiate turbulent fluid flow or otherwise disrupt the flow of any fluid traveling through the pipe. As another consideration, the heat of the open root weld cannot be too high causing metal shrinkage and, thus, draw back into the gap forming the open root.

To accomplish a quality pipe open root weld, without substantial inward protrusion of molten metal or metal draw back, a surface tension transfer (“STT”) short circuit arc welding method has been developed and used. STT welding was developed and is sold by The Lincoln Electric Company of Cleveland, Ohio under the trademark STT. STT welding is disclosed in various U.S. patents, including U.S. Pat. Nos. 5,148,001, 5,003,154, 5,001,326, 4,972,064, 4,897,523, 4,866,247, and 4,717,807, each of which are incorporated by reference so that this known technology need not be repeated.

The STT pipe welding process controls the initial welding pass of the pipe welding procedure to fill the open root. Although this type of welding process is extremely advantageous, a substantial amount of development work has been required to select welding wire for use in the short circuit welding process. It has been found that solid wire with the characteristics of the ANSI-AWS A 5. 1895 produces an excellent root pass weld bead. It has also been found that a cored electrode has substantial advantages when used to weld pipe sections with the STT welding process, which is disclosed in certain U.S. patents, including U.S. Pat. Nos. 5,961,863, 6,051,810, and 6,215,100, each of which are incorporated by reference. However, the open root pass weld bead presents unique welding challenges. Further, welding materials made from steel alloy P91 also provides unique challenges.

P91 steel provides various advantages in the power generation industry. Because of its high heat resistance and high creep resistance, P91 provides lower wall thicknesses or higher temperatures or pressures, each of which improves thermal efficiency. According to industry specifications, a low silicon (Si) content is generally required in P91 solid filler metal. However, root welding with SST and gas metal arc welding (“GMAW”) generally requires higher Si content for reasons of de-oxidation and wetting. Consequently, the present invention provides metal cored welding wire (i.e., electrode) that is acceptable for welding open root joints in P91 steel, with or without various shielding gases.

### SUMMARY OF THE INVENTION

A particular embodiment of the present invention includes a method of welding the ends of two pipe sections at the open root between said spaced ends, said method comprising: (a) selecting a metal cored welding wire having a steel sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum; (b) advancing said selected welding wire at a given wire feed rate toward said open root between two pipe ends to weld said pipe ends together by filing said open root in a first weld pass; (c) creating a welding current with a controlled waveform, said waveform including a succession of welding cycles each having a short circuit portion and a plasma arc portion with the plasma arc portion including in sequence a plasma boost segment, a tailout segment and a background current segment; (d) moving said welding wire along said open root as said welding current is passed through said wire to melt the wire and transfer the melted wire by surface tension transfer to said pipe ends in said open root; and, (e) forming said current waveform by a rapid succession of current pulses created by an oscillator at a rate of at least 18 kHz and with a width controlled by a pulse width modulator.

An additional embodiment of the present invention includes a method of short circuiting arc welding two spaced ends of two work piece sections along a groove existing between said two sections, said method comprising the steps of: (a) providing a metal cored electrode having a steel sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum; (b) positioning the ends of said sections to form a gap between said ends; (c) moving said electrode toward said groove as said electrode is moved along said groove; (d) melting said electrode by an electric wave comprising a short circuit transfer portion and a controlled melting portion; and, (e) controlling said melting portion of said electric wave to bridge said gap between said pipe sections for laying a root bead along said groove.

An additional embodiment of the present invention includes a method of welding the ends of two metal work pieces at the open root between said spaced ends, said method comprising: (a) selecting a metal cored welding wire having a steel sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum; (b) advancing said welding wire at a given wire feed rate toward said open root to weld said ends together by at least partially filing said open root in a first weld pass; (c) creating a welding current with a controlled waveform, said waveform including a succession of welding cycles each having a short circuit portion and a plasma arc portion; and (d) moving said welding wire along said open root as said welding current is passed through said wire to melt the wire and transfer the melted wire to said ends in said open root.

These and other objects and advantages will become apparent from the following description taken together with the accompanying drawings.

### BRIEF DESCRIPTION OF THE DRAWINGS

FIG. 1 is an enlarged partial view showing a welding wire passing through a torch movable along an open root between two pipe sections.

FIG. 2 is a view similar to FIG. 1 with the welding wire in the short circuit, metal transfer condition.

FIG. 3 is a perspective, cross-sectional view of the nozzle and electrode along Section A-A, as identified in FIG. 1.

FIG. 4 is a simplified diagram of an STT welder used in the invention.

FIG. 5 is a current wave form of the type used in practicing the present invention.

### DETAILED DESCRIPTION OF THE DRAWINGS

The present invention relates to a method of welding a pair of ends, such as of opposing pipe sections, made of steel alloy P91 at the open root between the ends by using a special welding wire in combination with the STT welding process.

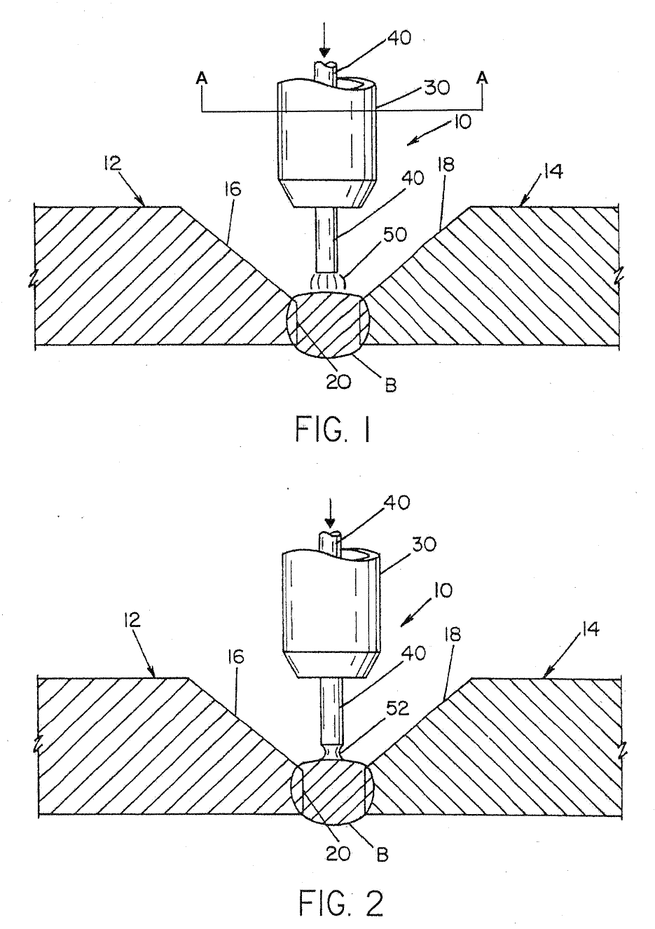

In FIGS. 1 and 2 the pipe welding operation 10 is used to weld the pipe sections 12, 14 having a gap or open root 20 defined by tapered ends 16, 18, the ends being spaced apart in accordance with standard practice. The first weld bead B is laid or deposited in the open root 20 by moving torch 30 around the pipe sections 12, 14 and along a path determined by the joint, including root pass 20 at the bottom. In accordance with the invention, a wire 40 is fed at a selected rate through torch 30 toward root pass 20 while welding current is passed through the welding wire. The welding current creates an arc 50 as shown in FIG. 1 to melt the end of the advancing wire 40. As the wire is converted to a molten ball and moved toward bead B, a short circuit condition 52 is created as shown in FIG. 2. This condition causes a transfer of molten metal from wire 40 to bead B. By moving torch 30 around open root 20, this alternate arcing condition and short circuit, metal transfer condition is continued.

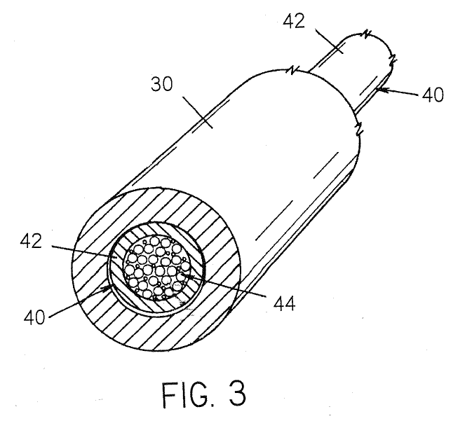

In FIG. 3, welding wire 40 is a metal cored wire having a metal sheath 42 and core 44. The sheath 42 may comprise any desired metal, such as, for example, steel or iron chromium. In one embodiment, sheath 42 comprises a high purity steel with 96% metal recovery with respect to wire. Sheath 42 and core 44 together, that is wire 40, may comprise about 0.08-0.13% by weight of carbon, about 0.60-1.20% by weight manganese, and about 0.0-0.40% by weight silicon. Further, wire 40 may also include sulfur, phosphorous, chromium, nickel, molybdenum, niobium, vanadium, nitrogen, copper, and aluminum. In accordance with the present invention, wire 40 may include about 0.0-0.015% by weight sulfur, about 0-0.020% by weight phosphorus, about 8.0-10.0% by weight chromium, about 0.0-0.80% by weight nickel, about 0.85-1.20% by weight molybdenum, about 0.03-0.07% by weight niobium, about 0.18-0.25% by weight vanadium, about 0.03-0.07% by weight nitrogen, about 0.0-0.15% by weight copper, and about 0.0-0.04% by weight aluminum. It is contemplated that other formulations or deviations may be made to the above-identified composition of welding wire 40 based on the specific application. By selecting and maintaining the composition of electrode 40, the advantages set forth in the introductory portion of this disclosure are realized, namely, the STT welding process may be used to properly and effectively weld and join P91 steel open root joints. A shielding gas may be used to protect the weld from the surrounding environment during the welding process, and may include, if used at all, any shielding gas known to one of ordinary skill in the art, including, for example, 68% argon 12% carbon dioxide 20% helium and any other shielding gas containing helium, which increases arc temperatures and overall weldability.

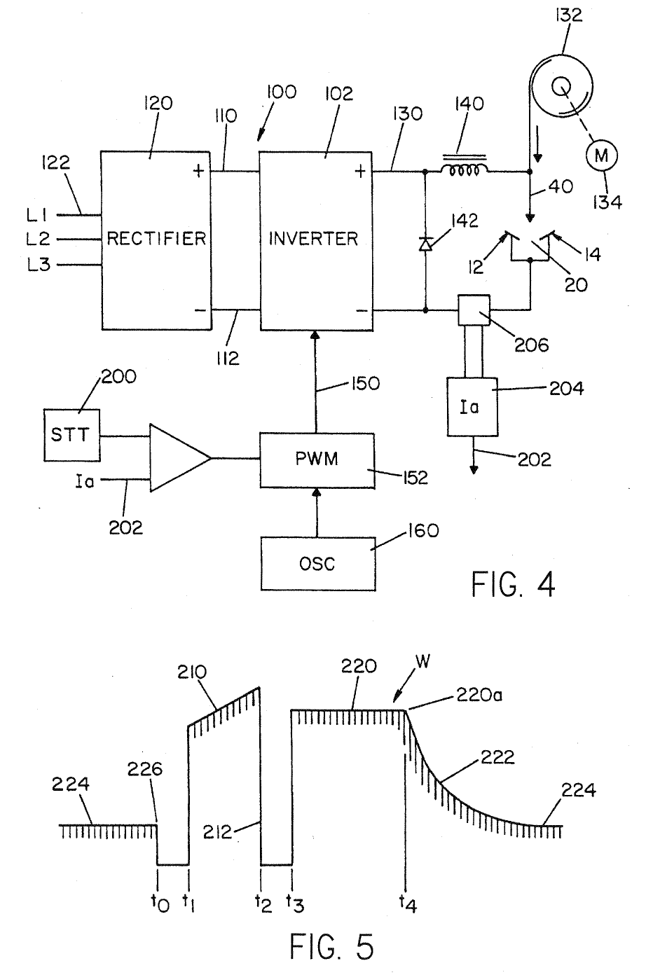

With reference to FIGS. 4 and 5, the STT welding process used in accordance with the present invention is shown. The waveform W, shown in FIG. 4, is the STT waveform created by the STT welder 100. In one embodiment, this welder may use either a down chopper or the illustrated high speed, switching inverter 102 with a DC input link having a positive terminal 110 and a negative terminal 112. However, it is contemplated that other control circuitry could be utilized. In the field, the STT welder or power supply is normally driven by a motor generator; however, for simplicity, the input is illustrated herein as a rectifier 120 with a three phase input power supply 122; however, any source may be used. The output 130 of STT welder is used to melt and deposit electrode or welding wire 40, which may be supplied by a supply reel 132 advancing toward the open root 20 between pipe sections 12, 14 by an electric motor 134 driven at a selected speed to control the wire speed rate. In accordance with standard STT practice, in one exemplary embodiment, a relatively small inductor 140 is provided in output 130 with a freewheeling diode 142 for the purposes of stabilizing the output welding procedure to follow the waveform. Wave form W, as shown in FIG. 4, may be controlled by the voltage on control line 150 of inverter 102. This input or control line has a voltage determined by the output of pulse width modulator 152 operated at a rate exceeding 18 kHz by oscillator 160. In one embodiment, the rate of pulses on line 150 is substantially greater than 20 kHz. Thus, inverter 102 outputs a rapid succession of current pulses created by oscillator 160 at a very high rate. Pulse width modulator 152 determines the width of each current pulse from inverter 120 to output 130. In accordance with standard STT practice, in one embodiment, wave shape W is determined by control circuit 200. This standard practice is generally shown in FIG. 10 of Stava U.S. Pat. No. 5,742,029. The wave shape control circuit 200 may have an output with a voltage that is compared to the voltage on line 202. This feedback voltage is representative of the arc current through wire 40. A voltage representing arc voltage is generated by current sensor 204 receiving current information from shunt 206. Still, it is contemplated that any control circuit may be used to determine the wave shape. Waveform W, as used in the present invention, is a single welding cycle repeated successively as wire 40 is melted and deposited between pipe sections 12, 14. Waveform W, in accordance with STT technology, and in one embodiment, includes a short circuit portion including a metal transfer short circuit pulse 210 where the current is dropped when the metal being transferred is electrically necked down and then ruptured. After the rupture or “fuse” waveform W transitions into an arc or plasma portion, comprising a plasma boost 220 having a controlled maximum current 220a, a tailout portion 222 and a background portion 224. It is contemplated and known that maximum current 220a may be greater than the maximum current of pulse 210. Background current is provided for sustaining the arc until the next short circuit at point 226 when the molten metal ball on the wire 40 shorts against pipe sections 12, 14 or against the bead B filling root pass 20. The above description of the STT welding process is a general discussion, and may comprise any form consistent with the standard STT practice, including the variations and embodiments discussed and contemplated in the U.S. patents incorporated by reference above.

After the open root is closed by bead B, the welding method shifts to a rapid filling of the remainder of the joint. This may be accomplished by any method know to one of ordinary skill in the art, such as, for example, by using submerged arc welding, shielded metal arc welding, flux cored arc welding to fill the joint. In one embodiment, the STT welder or power supply is also used in the joint filling operation where a number of high deposition passes are made around the pipe.

The invention has been described with reference to a various embodiments and alternates thereof. It is believed that many modifications and alterations to the embodiments disclosed will readily suggest themselves to one skilled in the art upon reading and understanding the detailed description of the invention. It is intended to include within the scope of this invention all such modifications and alterations in so far as they come within the scope of the present invention.

I claim:

1. A method of welding the ends of two pipe sections at the open root between said spaced ends, said method comprising:
(a) selecting a metal cored welding wire having a steel sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum;
(b) advancing said selected welding wire at a given wire feed rate toward said open root between two pipe ends to weld said pipe ends together by filing said open root in a first weld pass;
(c) creating a welding current with a controlled waveform, said waveform including a succession of welding cycles each having a short circuit portion and a plasma arc portion with the plasma arc portion including in sequence a plasma boost segment, a tailout segment and a background current segment;
(d) moving said welding wire along said open root as said welding current is passed through said wire to melt the wire and transfer the melted wire by surface tension transfer to said pipe ends in said open root; and,
(e) forming said current waveform by a rapid succession of current pulses created by an oscillator at a rate of at least 18 kHz and with a width controlled by a pulse width modulator.

2. The method as defined in claim 1 wherein said given percentage level of phosphorous is in the range of about 0.0-0.020% by weight.

3. The method as defined in claim 1 wherein said given percentage level of sulfur is in the range of about 0.0-0.015% by weight.

4. The method as defined in claim 1 wherein said given percentage level of chromium is in the range of about 8.0-10.0% by weight.

5. The method as defined in claim 1 wherein said given percentage level of nickel is in the range of about 0.0-0.80% by weight.

6. The method as defined in claim 1 wherein said given percentage level of molybdenum is in the range of about 0.85-1.20% by weight.

7. The method as defined in claim 1 wherein said given percentage level of niobium is in the range of about 0.03-0.07% by weight.

8. The method as defined in claim 1 wherein said given percentage level of vanadium is in the range of about 0.18-0.25% by weight.

9. The method as defined in claim 1 wherein said given percentage level of nitrogen is in the range of about 0.03-0.07% by weight.

10. The method as defined in claim 1 wherein said given percentage level of copper is in the range of about 0.0-0.15% by weight.

11. The method as defined in claim 1 wherein said given percentage level of aluminum is in the range of about 0.0-0.04% by weight.

12. The method as defined in claim 1 wherein said given percentage level of phosphorous is in the range of about 0.0-0.020% by weight, said given percentage level of sulfur is in the range of about 0.0-0.015% by weight, said given percentage level of chromium is in the range of about 8.0-10.0% by weight, said given percentage level of nickel is in the range of about 0.0-0.80% by weight, said given percentage level of molybdenum is in the range of about 0.85-1.20% by weight, said given percentage level of niobium is in the range of about 0.03-0.07% by weight, said given percentage level of vanadium is in the range of about 0.18-0.25% by weight, said given percentage level of nitrogen is in the range of about 0.03-0.07% by weight, said given percentage level of copper is in the range of about 0.0-0.15% by weight, and said given percentage level of aluminum is in the range of about 0.0-0.04% by weight.

13. The method as defined in claim 1 including filling the joint above said metal in said open root after said first weld pass by a filler welding wire.

14. The method as defined in claim 13 wherein said filler welding wire is a metal cored welding wire.

15. The method as defined in claim 1 further comprising the step of: providing a shielding gas that is composed in part of helium.

16. A method of short circuiting arc welding two spaced ends of two work piece sections along a groove existing between said two sections, said method comprising the steps of:
(a) providing a metal cored electrode having a steel sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum;
(b) positioning the ends of said sections to form a gap between said ends;
(c) moving said electrode toward said groove as said electrode is moved along said groove;
(d) melting said electrode by an electric wave comprising a short circuit transfer portion and a controlled melting portion; and,
(e) controlling said melting portion of said electric wave to bridge said gap between said pipe sections for laying a root bead along said groove.

17. The method as defined in claim 16, wherein said given percentage level of phosphorous is in the range of about 0.0-0.020% by weight, said given percentage level of sulfur is in the range of about 0.0-0.015% by weight, said given percentage level of chromium is in the range of about 8.0-10.0% by weight, said given percentage level of nickel is in the range of about 0.0-0.80% by weight, said given percentage level of molybdenum is in the range of about 0.85-1.20% by weight, said given percentage level of niobium is in the range of about 0.03-0.07% by weight, said given percentage level of vanadium is in the range of about 0.18-0.25% by weight, said given percentage level of nitrogen is in the range of about 0.03-0.07% by weight, said given percentage level of copper is in the range of about 0.0-0.15% by weight, and said given percentage level of aluminum is in the range of about 0.0-0.04% by weight.

18. A method of welding the ends of two metal work pieces at the open root between said spaced ends, said method comprising:
(a) selecting a metal cored welding wire having a metal sheath and a core comprising about 0.08-0.13% by weight of carbon, about 0.60-1.20% by weight manganese, and about 0.0-0.40% by weight silicon, as well as sulfur, phosphorous, chromium, nickel, molybdenum, niobium, vanadium, nitrogen, copper, and aluminum;
(b) advancing said welding wire at a given wire feed rate toward said open root to weld said ends together by at least partially filing said open root in a first weld pass;
(c) creating a welding current with a controlled waveform, said waveform including a succession of welding cycles each having a short circuit portion and a plasma arc portion; and,
(d) moving said welding wire along said open root as said welding current is passed through said wire to melt the wire and transfer the melted wire to said ends in said open root.

19. The method as defined in claim 18, wherein said given percentage level of phosphorous is in the range of about 0.0-0.020% by weight, said given percentage level of sulfur is in the range of about 0.0-0.015% by weight, said given percentage level of chromium is in the range of about 8.0-10.0% by weight, said given percentage level of nickel is in the range of about 0.0-0.80% by weight, said given percentage level of molybdenum is in the range of about 0.85-1.20% by weight, said given percentage level of niobium is in the range of about 0.03-0.07% by weight, said given percentage level of vanadium is in the range of about 0.18-0.25% by weight, said given percentage level of nitrogen is in the range of about 0.03-0.07% by weight, said given percentage level of copper is in the range of about 0.0-0.15% by weight, and said given percentage level of aluminum is in the range of about 0.0-0.04% by weight.
